(19) United States
(12) Patent Application Publication
(10) Pub. No.: US 2026/0021518 A1
(43) Pub. Date: Jan. 22, 2026

(54) CLEANING SYSTEM FOR THE PARTIAL EXTERNAL CLEANING OF CAN BLANKS, METHOD FOR THE PARTIAL EXTERNAL CLEANING OF CAN BLANKS AND DIGITAL PRINTING SYSTEM FOR CAN BLANKS

(71) Applicant: Hinterkopf GmbH, Eislingen/Fils (DE)

(72) Inventor: Florian GOLLER, Schorndorf (DE)

(21) Appl. No.: 19/264,126

(22) Filed: Jul. 9, 2025

(30) Foreign Application Priority Data
Jul. 18, 2024 (DE) 10 2024 120 460.5

(51) Int. Cl. B08B 9/08; B08B 1/30; B08B 1/50; B41J 29/17

(52) U.S. Cl. CPC B08B 9/0804; B08B 1/30; B08B 1/50; B08B 9/0826; B41J 29/17

(57) ABSTRACT

A cleaning system for the area-wise external cleaning of can blanks, with a conveyor to convey can blanks along a path of movement with a superimposed rotational movement about a rotational axis aligned transversely to the path of movement, and with a cleaning device which has a cleaning belt, the outer surface of which defines a cleaning path which extends at least in sections along the path of movement and which provides a contact between the cleaning belt and a surface area of the can blanks.

### CROSS REFERENCE TO RELATED APPLICATION

The present application claims the benefit of German application DE 10 2024 120 460.5, filed Jul. 18, 2024, which is incorporated herein by reference.

### SUMMARY OF THE INVENTION

The invention relates to a cleaning system for the partial or selective external cleaning of can blanks, a method for the partial or selective external cleaning of can blanks and a digital printing system for can blanks.

The can blanks are, for example, beverage can blanks made of metal or beverage bottle blanks made of plastic or metal or aerosol can blanks made of metal. It is preferred that the can blanks are rotationally symmetrical and are produced, for example, in a forming process from a disc-shaped metal base body, in particular an aluminum round blank, or in a plastic injection molding process or a plastic blow molding process. During the manufacture of the can blanks, it may be provided that the respective can blank is wetted, at least in some areas, with a release agent or a lubricant in order to be able to carry out a manufacturing step, for example a drawing process on a metal can blank. This can lead to the problem that an area of the outer surface of the can blank, which is to be printed in a subsequent processing step using an inkjet digital printing process, has unfavorable adhesion properties for the printing ink to be applied in the inkjet digital printing process due to wetting with the release agent or lubricant.

The task of the invention is to provide a cleaning system for the selective external cleaning of can blanks, a method for the selective external cleaning of can blanks, a use of a cleaning system for the selective external cleaning of can blanks, and a digital printing system for can blanks, with which efficient and environmentally friendly cleaning of the can blanks can be achieved.

This task is solved according to a first aspect of the invention by a cleaning system for the partial external cleaning of can blanks, which has a conveyor for conveying can blanks along a path of movement with a superimposed rotational movement about an axis of rotation aligned transversely to the path of movement, a cleaning device with a cleaning belt, the outer surface of which defines a cleaning path that extends at least in sections or partially along the path of movement and is designed for contact between the cleaning belt and a surface area of the can blanks.

The cleaning system is intended to clean an area of an outer surface of the can blank, which is then to be printed using an inkjet digital printing process. This does not exclude the possibility of printing other areas of the outer surface of the can blank using the inkjet digital printing process. The partial cleaning of the outer surface of the can blank takes place in the area of the outer surface which, in a previous manufacturing step for the can blank, was wetted with a lubricant or a release agent and which, without the cleaning process, would therefore compromise the reliable adhesion of the printing ink applied in the inkjet digital printing process.

For example, in the case of a metal beverage can that is to be printed using the inkjet digital printing process, a deformation step is provided in the area of the can opening prior to printing, which is carried out as a drawing-in process and leads to a narrowing of the can opening. In order to carry out this drawing-in process, the can blank is wetted with lubricant around the area of the can opening. The lubricant is preferably a food-safe lubricant that is approved for human consumption by the relevant food authorities and can therefore remain on the can blank.

In order to ensure that the printing ink applied in the inkjet digital printing process adheres not only to areas of the outer surface which have not been wetted by the lubricant, but also to the area of the outer surface wetted by the lubricant, this area of the outer surface must be cleaned in order to at least reduce the amount of lubricant on the outer surface of the can blank. In principle, a thermal process could be used to evaporate the lubricant, but this has disadvantages in terms of energy efficiency and environmental pollution from lubricant vapors. Alternatively, a washing process could be used, but this would also be disadvantageous in terms of energy efficiency due to the subsequent drying of the can blank and, depending on the detergent used, detergent residues remaining on the outer surface of the can blank could also be problematic for the adhesion of the printing ink.

With the help of the cleaning belt of the cleaning device, however, mechanical cleaning of the area of the outer surface of the can blank is carried out, in which a reduction of the amount of lubricant on the outer surface of the can blank by 50 to 90 percent can be achieved by a relative movement between the can blank and the absorbent, in particular sponge-like, cleaning belt. Furthermore, the friction between the cleaning belt and the outer surface of the can blank, which occurs during the relative movement, ensures that the quantity of lubricant remaining on the outer surface of the can blank is distributed evenly. The lubricant tends to form droplets due to the surface energy of the typically painted outer surface and its own surface tension. The reduction in the amount of lubricant in conjunction with the friction occurring during the cleaning process ensures that after the cleaning process, even if a large number of lubricant droplets remain on the outer surface, that these droplets are so small that they are covered by the ink droplets emitted in the inkjet digital printing process in such a way that the adhesion of the ink droplets to the outer surface is not compromised. Furthermore, the lubricant droplets are preferably so small that the ink droplets are stable enough to prevent the lubricant droplets from breaking through the covering layer formed by the covering ink droplets, even during subsequent frictional contact of the printed outer surface of the can blank with other objects.

For efficient cleaning with the cleaning device, the cleaning system has a conveyor designed to convey the can blanks along a path of movement and thereby impart a rotational movement to the can blanks, with the axis of rotation of this rotational movement being aligned transversely to the path of movement. For example, it may be provided that the movement path is aligned in a straight line in the horizontal direction and that cleaning is to be carried out on rotationally symmetrical, in particular essentially circular cylindrical, can blanks. These can blanks are fed to the cleaning system by means of a conveyor upstream of the cleaning system, for example a conveyor belt, and pass through the cleaning system along the path of movement. Since the conveyor is designed to additionally set the can blanks in a rotational movement that is aligned transversely to the movement path, it may be provided, for example, that the can blanks rotate about their axes of rotational symmetry aligned in the vertical direction and thus transversely to the horizontal movement path.

The cleaning belt is arranged for partial contact with the outer surface of the can blanks on the conveyor. The area of the outer surface of the cleaning belt that comes into contact with the outer surface of the can blanks during transport along the path of movement is also referred to as the cleaning section. This cleaning section extends along the path of movement, whereby the path of movement may be longer than the cleaning section.

The cleaning belt can be made of a single material, for example a natural material or plastic material suitable for absorbing the lubricant. It is preferred that the cleaning belt is of a multi-layer construction and has a flexible, dimensionally stable carrier layer and an elastic suction layer made of a natural material or plastic material designed to be absorbent for the lubricant. The task of the carrier layer is to transfer forces between the cleaning device and the can blanks, while the task of the elastic absorbent layer is to elastically adapt to the outer surface of the can blanks under the influence of the forces acting between the cleaning device and the can blanks. This elastic adaptation is intended to ensure that, during the relative movement between the cleaning belt and the can blank, as much of the lubricant as possible can be absorbed by the suction layer and that the lubricant remaining on the outer surface of the can blank is distributed as finely as possible.

Advantageous further developments of the invention are the subject of the subclaims.

It is advantageous if the cleaning device has a belt guide for the cleaning belt, wherein the belt guide comprises a drive which is designed for linear movement of the cleaning belt along the cleaning path. The belt guide has the task of guiding the cleaning belt in such a way that the desired force transmission from the cleaning belt to the can blanks is enabled. Furthermore, the belt guide has the task of initiating a linear movement on the cleaning belt along the cleaning path in order to bring about the desired relative movement between the outer surface of the can blank and the cleaning belt. In this case, either a synchronous movement or a counter-rotating movement or an alternation between a synchronous movement and a counter-rotating movement between the cleaning belt and the can blank can be provided. In a synchronous movement, the local direction of movement of the cleaning belt at a point of contact with the can blank is aligned in the same direction as the local direction of movement of the can blank at this point of contact. In order to achieve the desired relative movement between the can blank and the cleaning belt, the local speeds of movement of the can blank and the cleaning belt at the point of contact differ. In a counter-rotating movement, the local direction of movement of the cleaning belt at the point of contact with the can blank is aligned in the opposite direction to the local direction of movement of the can blank at this point of contact. A change between synchronous movement and counter-rotating movement can be achieved, for example, by a linear oscillating movement of the cleaning belt.

The synchronous movement and/or counter-rotating movement of the cleaning belt is caused by the drive, which may be an electric motor, a hydraulic motor, or a pneumatic motor designed to move the cleaning belt linearly in the area of the cleaning section. For this purpose, a pure linear drive such as an electric linear actuator or a hydraulically or pneumatically operated telescopic cylinder can be used. Alternatively, the drive is designed to provide a rotary movement, and the cleaning belt can be unwound from a reel or wound onto a reel. Preferably a second reel is provided onto which the cleaning belt is wound or from which the cleaning belt is unwound. For example, the cleaning belt can be accommodated in a cassette in which two spools are rotatably mounted, the drive driving one of the spools in order to wind the cleaning belt onto this spool and thereby unwinding it from the other spool. The cleaning path extends between the two spools, wherein guide means for the cleaning belt may be provided to ensure that the cleaning belt always runs parallel along the cleaning path.

It is advantageous if the belt guide has a belt washing device for the cleaning belt away from the cleaning section, which washing device is designed for continuous washing of the cleaning belt. The belt washing device serves to feed the cleaning belt, which is contaminated with lubricant after contact with the outer surface of the can blanks, to a washing process in which at least the majority of the lubricant is removed from the cleaning belt. Accordingly, the belt washing device is arranged downstream of the cleaning section so that the cleaning belt only passes through the belt washing device after it has passed through the cleaning section and the lubricant has been at least partially removed from the can blanks. To carry out the washing process, the cleaning belt is designed to pass through the belt washing device along a straight or at least partially curved cleaning path, thus performing a relative movement, also referred to as a through-flow movement. The belt washing device may have one or more spray nozzles with which a washing liquid, for example water mixed with a grease-dissolving substance, is sprayed onto the outer surface of the cleaning belt. In addition or as an alternative, the belt washing device may have a washing drum which is at least partially surrounded by the cleaning belt and has a perforated surface from which washing liquid can be pressed into the cleaning belt. The belt washing device can be designed as a closed system in which the washing liquid delivered to the cleaning belt remains within the belt washing device and is circulated in a cycle process, for example. Alternatively, the belt washing device can be designed as an open system in which excess washing liquid can leave the belt washing device and, for example, drip into a drip tray arranged below the belt washing device.

In a further development of the invention, it is envisaged that the belt guide away from the cleaning section has a belt drying device for the cleaning belt, which is designed for continuous drying of the cleaning belt. Since the cleaning belt must only be dried once it has already passed through the belt washing device, the belt drying device is arranged downstream of the belt washing device and thus also downstream of the cleaning section. Like the belt washing device, the belt drying device is designed for treating the cleaning belt in a continuous process and has at least one drying component from the group: squeeze roller, perforated drum, suction device. A squeeze roller is rotatably mounted on a machine frame of the cleaning system and compresses the cleaning belt locally in order to press the washing liquid absorbed in the cleaning belt together with the lubricant out of the cleaning belt by means of the elastic deformation of the cleaning belt. For example, the cleaning belt can be guided through a squeeze gap which is bounded by two squeeze rollers arranged opposite each other or by a squeeze roller and a sliding surface arranged opposite each other. In addition or as an alternative, a perforated drum can be used to dry the cleaning belt. A perforated drum is designed, for example, as a circular cylindrical sleeve which is rotatably mounted on a machine frame of the cleaning system, a plurality of holes being provided in the wall of the sleeve. It is also provided that the perforated roller is at least partially surrounded by the cleaning belt, whereby, due to a preload exerted on the cleaning belt, a compressive effect is exerted on the cleaning belt in the area of the perforated drum and washing liquid and lubricant can flow through the holes into the interior of the perforated roller, from where they can flow out through an opening at the front of the perforated roller. In an extraction device, a suction nozzle arranged directly opposite the cleaning belt is subjected to negative pressure in order to extract washing liquid and lubricant from the cleaning belt.

In a further embodiment of the invention, a first end region of the cleaning section is defined by a first deflection roller assigned to the belt guide, which is at least partially surrounded by the cleaning belt, and a second end region of the cleaning section is defined by a second deflection roller assigned to the belt guide, which is at least partially surrounded by the cleaning belt. This achieves advantageous positioning of the cleaning belt along the cleaning section. Depending on the pretension of the cleaning belt, the cleaning section runs either in a straight line or in an arc between the first and second deflection rollers and always lies tangentially to the two deflection rollers.

It is preferred that the cleaning belt is designed as an endless loop. This allows the cleaning belt to be guided in a continuous, infinite circular movement along the cleaning section and to be treated away from the cleaning section, for example with the aid of a belt washing device and a belt drying device, in such a way that an advantageous cleaning effect can always be ensured by the cleaning belt along the cleaning section.

It is advantageous if the conveyor has an endless conveyor belt which partially encircles a first pulley, which determines the start of the movement path, and partially encircles a second pulley, which determines the end of the movement path, wherein the conveyor belt partially encircles a further pulley which is assigned to a drive motor. This enables the conveyor to provide a continuous conveying movement for the can blanks along the path of movement, which is of particular interest in the mass production of can blanks. The drive motor is designed to provide a rotary movement to the further pulley and thereby causes the endless circulation of the conveyor belt also around the first and second pulleys.

In an advantageous further development of the invention, it is provided that opposite a conveyor belt section extending between the first pulley and the second pulley, a rolling surface is arranged parallel to the path of movement, which together with the conveyor belt section defines a conveying gap for the can blanks, which conveyor gap is matched to an outer diameter of the can blanks. The rolling surface is designed to support the typically circular cylindrical side walls of the can blanks. The distance between the conveyor belt section and the rolling surface is such that force is transmitted between the conveyor belt and the rolling surface in a direction perpendicular to the rolling surface. This force transmission results in a normal force acting from the rolling surface onto the side walls of the can blanks. This normal force, together with a coefficient of static friction that depends on the material properties of the outer surfaces of the can blanks and the material properties of the rolling surface, determines a static friction force aligned in the direction of the movement path. This static friction force results in a torque on the can blank and causes the desired rotational movement of the can blank, which is superimposed on the linear movement of the can blank when it is conveyed along the path of movement. This superimposed rotational movement ensures that the can blank comes into contact with the cleaning belt over its entire circumference during transport along the path of movement, thus ensuring that the outer surface area of the can blank contaminated with lubricant is completely cleaned.

It is preferred that the rolling surface and the conveyor belt section are aligned parallel to each other and that the outer surface of the cleaning belt is aligned at an angle between 0 degrees and 45 degrees to the rolling surface or to the conveyor belt section. It is preferably provided that the angle between the outer surface of the cleaning belt and the rolling surface or the conveyor belt section is adjustable so that the largest possible contact area between the cleaning belt and the can blank can be ensured. The angle setting for the cleaning belt depends in particular on the geometry of the can blank, which is usually tapered in the area of its opening.

It is advantageous if a transport device extending at least along the path of movement is arranged between a conveying plane determined by the conveyor belt section and a rolling plane determined by the rolling surface, which transport device has a circulating conveyor belt designed to support a bottom area of the can blank. The task of the transport device is to provide additional support for the can blanks so that they can be guided in a well-defined manner along the path of movement. It is preferably provided that the path of movement is aligned in the horizontal direction and that the conveyor belt, which may be designed, for example, as an endless belt or as an endless link chain, is arranged in the vertical direction below the conveyor belt section and the rolling surface and forms a horizontally aligned support surface for the can blanks. It is particularly preferred that the can blanks rest with their bottoms on the conveyor belt so that the openings of the can blanks are located in the vertical direction above the rolling surface.

According to an inventive aspect a method for cleaning the outside of can blanks in sections is provided, comprising the following steps: moving a conveyor belt along a path of movement, feeding a can blank into a conveyor gap defined by a conveyor belt section of the conveyor belt and a rolling surface arranged opposite the conveyor belt section in order to cause the can blank to be conveyed along a path of movement with a superimposed rotational movement about an axis of rotation aligned transversely to the path of movement, in order to bring the can blank into contact with a cleaning belt whose outer surface defines a cleaning path extending at least in sections along the path of movement, wherein the external cleaning of the can blank is brought about by contact between the cleaning belt and a surface area of the can blanks.

According to another inventive aspect the cleaning system according to the invention is used for the partial external cleaning of can blanks.

According to another inventive aspect a digital printing system for printing can blanks using an inkjet digital printing process is provided, which comprises a cleaning system according to the invention and a digital printing machine, wherein the digital printing machine is arranged downstream of the cleaning system along a conveyor path for can blanks.

With a digital printing machine, each can blank can be provided with an individual decoration, or alternatively, several can blanks can be provided with the same decoration. In the digital printing process, ink droplets emitted from one or more digital print heads are applied to the outer surface of the can blank without contact. The printing ink used for this purpose is usually cured with ultraviolet light after being applied to the outer surface of the can blank. To ensure that the can blanks can be printed advantageously with the digital printing machine, whereby the adhesion of the printing ink to the outer surface of the can blanks is not impaired by lubricant residues as far as possible, the digital printing machine is arranged in a can production line in such a way that the can blanks to be printed have already been cleaned by the cleaning system when they are fed to the digital printing machine.

In a further development of the digital printing system, the digital printing machine comprises a machine frame having a rotatably mounted workpiece rotary table with can holders for fixing individual can blanks, a drive for initiating a rotary stepping movement on the workpiece rotary table, and at least one inkjet digital print head for printing on an outer surface of a can blank held in a can holder of the workpiece rotary table.

Such digital printing machines are known, for example, from the disclosure documents EP 2 860 515 A1, EP 3 473 446 A1, and EP 4 155 082 A1.

### BRIEF DESCRIPTION OF THE DRAWINGS

An advantageous embodiment of the invention is shown in the drawing. Here,

FIG. 1 shows a highly schematic representation of a digital printing system with a cleaning system and a digital printing machine,

FIG. 2 shows a perspective view of the cleaning system according to FIG. 1, wherein the cleaning system comprises a conveyor, a cleaning device and a transport device,

FIG. 3 shows a perspective view of the cleaning device and the transport device, and

FIG. 4 shows a perspective view of the cleaning device according to FIGS. 2 and 3 in a view from below.

### DETAILED DESCRIPTION

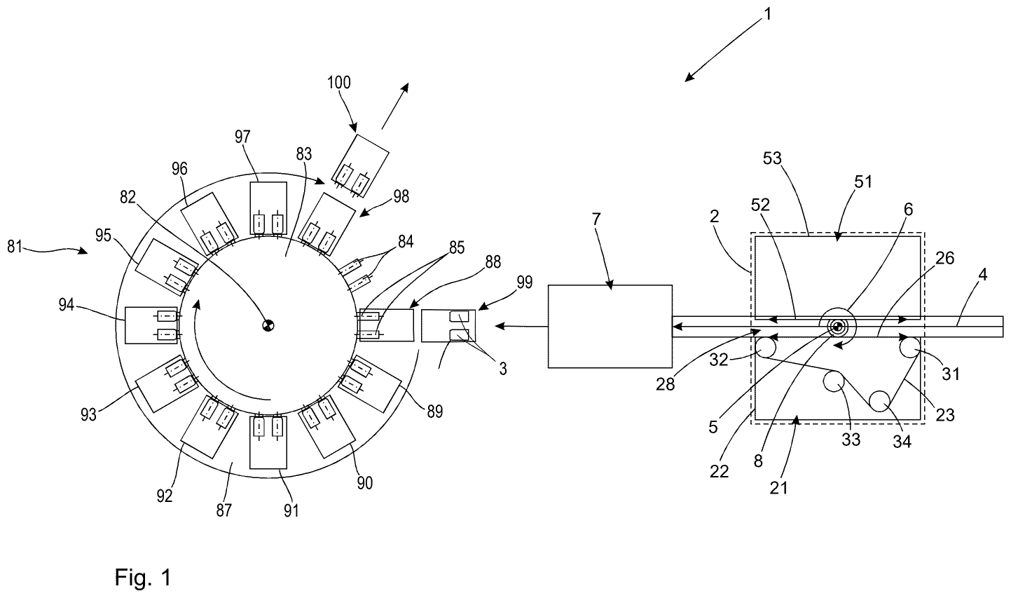

A digital printing system 1 shown in FIG. 1 comprises a cleaning system 2 and a digital printing machine 81.

The digital printing machine 81 comprises a workpiece rotary table 83 mounted rotatably about an axis of rotation 82 and a plurality of workpiece holders 84, which are exemplarily mounted in pairs on the workpiece rotary table. The workpiece holders 84 are mounted so that they can be rotated individually about rotation axes 85 by means of drive means (not shown) and are designed to hold sleeve-shaped can blanks 3. In an annular area 87 swept by the workpiece holders 84 during a rotary movement of the workpiece rotary table 83 about the axis of rotation 82, which annular area 87 extends in the radial direction around the workpiece rotary table 83, there are several work stations 88 to 98 which are designed for machining and/or inspecting the can blanks 3.

Workstation 88 is a loading station at which the can blanks 3 are, for example, pushed in pairs onto the workpiece holders 84 by a transport device 99 which is coupled to a loading system 7 (not shown in detail). The task of the loading system 7 is to arrange the can blanks 3, which are transported in a line along the movement path 6 with their axes of rotational symmetry aligned vertically and coaxially with the axis of rotation 5, in pairs and to transfer them in a way to achieve a horizontal alignment of the axes of rotational symmetry, so that the workstation 88 can pick up the can blanks 3 from the loading system 7 and feed them to the digital printing machine 81.

As an example, a first optical scan of the can blanks 3 at workstation 89 determines the rotational position of the can blanks 3, for example to ensure correct rotational alignment of the can blanks 3 for a printing process taking place at workstation 90. This is particularly important if the surface of the objects to be printed has features that must match the print image to be applied in a specified manner. These features may, for example, be local embossing in and/or from the surface of the can blanks 3 and/or pre-printed areas which in turn are intended to serve as a primer for subsequent printing.

The workstation 90 is designed as an inkjet printing station at which the can blanks 3 are printed during a rotational movement about respective rotational axes 85 using at least one inkjet print head (not shown) in a specified area, preferably over the respective circumference.

Workstation 94 is designed as an inspection device. The other workstations 91 to 93 and 95 to 97 are used for further processing of the can blanks 3, for example for curing the printed image or for applying a protective lacquer to the print.

At workstation 98, an unloading process takes place in which the can blanks 3 are removed from the mandrel-like workpiece holders 84 with the aid of a transport device 100 and fed to a further transport system (not shown in detail).

The workpiece rotary table 84 performs a rotary step movement for the stepwise processing of the can blanks 3 at the respective work stations 88 to 98, in which the workpiece holders 84, which are arranged in pairs, are transported from a position opposite the respective work station 88 to 98 to a position opposite the respective subsequent work station 88 to 98, wherein the rotary step movement takes place as a sequence of acceleration from standstill to a target speed, deceleration from the target speed reached, and a subsequent standstill time. Preferably, a drive for the workpiece rotary table 83, which is not shown in detail, is designed such that the acceleration and deceleration of the workpiece rotary table 83 can be freely adjusted over a wide range and the dwell time or standstill time can be freely adjusted and adapted to the requirements of the machining of the respective can blanks 3 at the workstations 88 to 98.

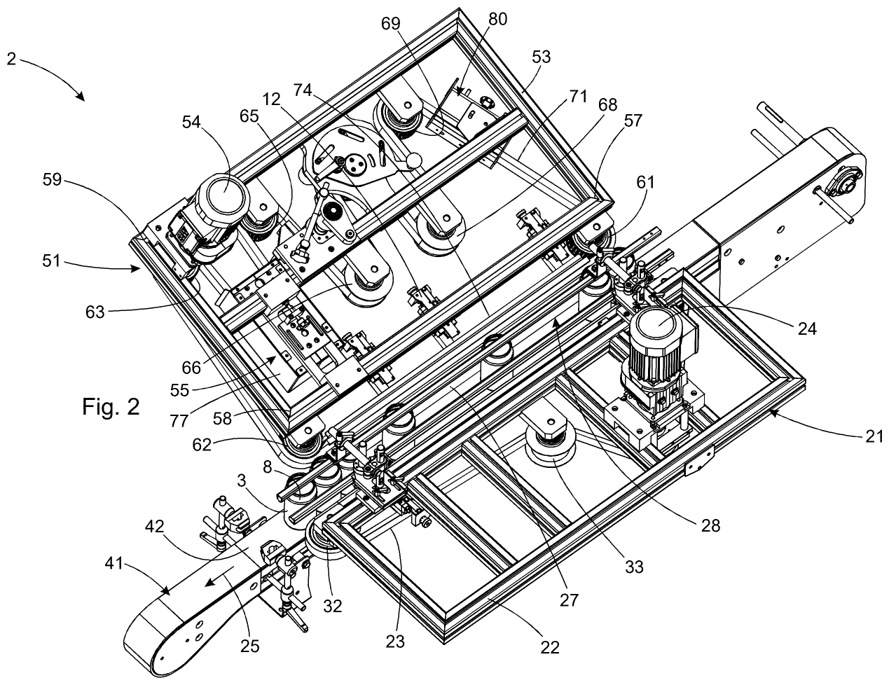

Upstream of the digital printing machine 81 is the cleaning system 2, which is designed for at least partial cleaning of a peripheral surface on the outer circumference of the can blanks 3, as shown in more detail in FIGS. 2 to 4 and described in more detail below.

As shown in FIG. 1, which is to be understood as a top view looking down vertically onto the digital printing system 1, the can blanks 3 are conveyed by a conveyor 21 along a movement path 4, which is shown here purely as an example and is aligned horizontally, through the cleaning system 2. This causes a linear movement of the can blanks 3 along the movement path 4 to overlap with a rotational movement of the can blanks 3 about a rotational axis 5 aligned transversely to the movement path 4 and, in the illustration in FIG. 1, normal to the plane of the illustration. This superimposed movement causes the can blanks 3, as they move along the movement path 4, to come into contact over their entire circumference, but not necessarily over their entire outer surface, with a cleaning section 52 of a cleaning device 51, which extends in sections along the movement path 4.

The cleaning section 52 is oriented parallel to the movement path 4 and is arranged in such a way that a shoulder area 8 of the can blanks 3 comes into contact with a cleaning belt 53 and, due to the superimposition of the linear movement and the rotational movement, a wiping movement is caused between the cleaning belt 53 and the shoulder area 8 for the can blank 3. This wiping movement removes a significant proportion of the lubricant applied to the shoulder area 8 of the can blank during a previous forming step.

FIG. 2 shows a perspective view of the cleaning system 2 shown schematically in FIG. 1. The cleaning system 2 comprises the cleaning device 51 and the conveyor 21. The following description refers to FIGS. 2 to 4:

For example, the cleaning device 51 has a rectangular support frame 53 to which the individual components of the cleaning device 51 are attached. Some of the components are attached directly to the support frame 53, while other components are connected to the support frame 53 via unlabeled, purely exemplary plate-shaped brackets.

The cleaning device 51 comprises a drive motor 54 mounted on the support frame 53, a belt washing device 55, and a belt drying device 56. Furthermore, the cleaning device 51 comprises, purely by way of example, a total of nine deflection rollers 61 to 69, some of which perform specific functions described in more detail below. The deflection rollers 61 to 69, together with the components described in more detail below, which also interact with the endless, closed-ring cleaning belt 71, form the belt guide.

The first deflection roller is arranged at a first corner 57 of the support frame 53 and, together with the second deflection roller 62, which is arranged at a second corner 58 of the support frame 53, serves to tension the cleaning belt 71 along the cleaning path 52. In order to ensure an advantageous cleaning effect of the cleaning belt 71, a support strip 74 extending between the first deflection roller 61 and the second deflection roller 62 is assigned to a rear side of the cleaning belt 71. However, the cleaning effect for the can blanks 3 can also be achieved without the support strip 74. The support strip 74 is connected to the support frame 53 by means of adjustable holders 12, wherein the holders 75 are designed for position adjustment of the support strip 74 in at least one spatial direction, preferably in two spatially perpendicular directions, in particular in three spatially perpendicular directions.

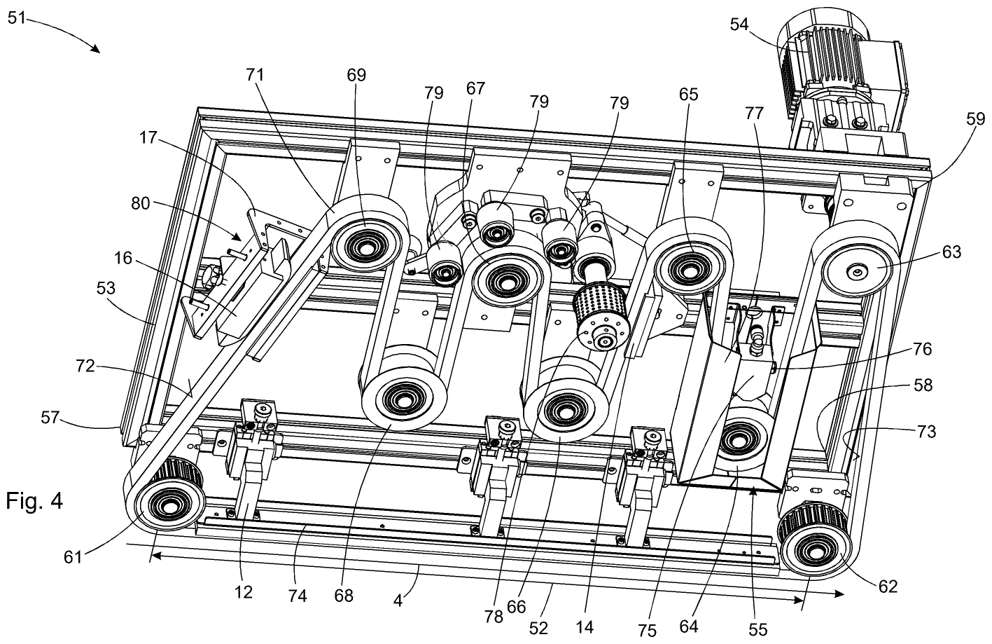

At the end of the cleaning section 52, the cleaning belt 71 partially wraps around the second deflection roller 62 and then runs toward the third deflection roller 63, which serves as a drive roller and converts a rotational movement of the drive motor 54 into a circular movement of the cleaning belt 71. Starting from the third deflection roller 63, the cleaning belt 71 runs toward the fourth deflection roller 64, which is part of the belt washing device 55. By way of example, it is provided that a 180-degree wrap around the fourth deflection roller 64 is provided in the belt washing device 55 and that a spray head 75 is arranged adjacent to the fourth deflection roller 64. The spray head 75 carries, purely by way of example, two spray nozzles aligned in opposite spatial directions, whereby only one spray nozzle 76 is visible in the representation in FIG. 4, while the other spray nozzle is concealed by a splash guard 77 arranged around the belt washing device 55 and designed, purely by way of example, as a sheet metal bending part. The spray nozzle 76 and the invisible spray nozzle of the spray head 75 are designed for spraying a washing liquid, for example water mixed with a grease-dissolving substance, onto the front side 72 of the cleaning belt 71, which serves as the outer surface along the cleaning section 52. For this purpose, the spray head 75 is connected (in a manner not shown) to a washing liquid pump, which can pump the washing liquid from a tank (not shown) and supply it under pressure to the spray head 75.

After passing through the belt washing device 55, the cleaning belt 71 is deflected several times by the deflection rollers 65 to 69 and passes through a perforated drum 78, several squeeze rollers 79, and a suction device 80. The perforated drum 78 is designed as a sleeve-shaped hollow body, wherein a cylinder wall of the perforated drum 78 is provided with a plurality of bores. Opposite the perforated drum 78 is a support plate 14 which supports the transfer of force from the perforated drum 78 to the cleaning belt 71 and thus enables local compression of the cleaning belt 71. This presses washing liquid from the cleaning belt 71 into the holes in the cylinder wall of the perforated drum 78, where it can flow out through holes in the front of the perforated drum 78.

Three squeeze rollers 79 are assigned to the seventh deflection roller 67 purely as an example, each of which is designed to press the cleaning belt 71 against the seventh deflection roller 67 and thereby press washing liquid out of the cleaning belt 71. By way of example, the three squeeze rollers are kinematically coupled to one another via a common adjustment device 15, whereby the adjustment device 15 can be used to adjust the distance between the squeeze rollers 79 and the seventh deflection roller 67. Alternatively, each of the squeeze rollers 79 may be designed for individual distance adjustment relative to the seventh deflection roller 67.

After being deflected around the eighth deflection roller 69 and the ninth deflection roller 69, the cleaning belt 71 passes through the suction device 80, which comprises a suction shoe 16 that is adjustably arranged on a U-shaped suction frame 17. The suction shoe 16 has a cavity, not visible in FIGS. 2 to 4, which is open in the direction of the cleaning belt 71 and can be subjected to negative pressure to enable washing liquid to be sucked out of the cleaning belt 71.

The perforated drum 78 with the associated support plate 14, together with the squeeze rollers 79 and the suction device 80, forms the belt drying device 56. Depending on the application, it is possible to use only the perforated drum 78 with the associated support plate 14, or only the squeeze rollers 79, or only the suction device 80, or a combination of two of these components in a non-illustrated embodiment of the belt drying device.

The conveyor shown in FIG. 2 has a purely exemplary rectangular support frame 22 composed of profile parts, on which three belt pulleys 31, 32, 33 are rotatably mounted, which are designed to guide an endless conveyor belt 23 forming a closed ring, as shown in strictly schematic form in FIG. 1. Furthermore, an electric drive motor 24 is mounted on the support frame 22, which drive motor 24 is designed to provide a rotary movement and can transmit this rotary movement to a belt pulley 34. The belt pulley 34 associated with the drive motor 24 sets the conveyor belt 23 in a circular motion, whereby a direction of movement imposed on the conveyor belt 23 determines the direction 25 of the path of movement 4 shown in FIG. 1. The conveyor belt 23 is designed such that it runs at least largely in a straight line between the first pulley 31 and the second pulley 32 and defines a conveyor belt section 26 in this area, in which the conveyor belt 23 can come into force-transmitting contact with the side walls of can blanks 3. In this case, a force transmission takes place from the conveyor belt 23 to the side walls of the can blanks 3, whereby the necessary support of the can blanks 3 is provided by a rolling surface 27 arranged opposite the conveyor belt section 26. The rolling surface can, for example, be fixed to the support frame 54 of the cleaning device 51 or to a transport device 41 described in more detail below and extends along the movement path 4. The conveyor belt 23 and the rolling surface 27 thus define a conveyor gap 27 through which the can blanks 3 are moved along the movement path 4 with a superimposed linear movement along the movement path 4 and a rotational movement about the axis of rotation 5 aligned transversely to the movement path 4.

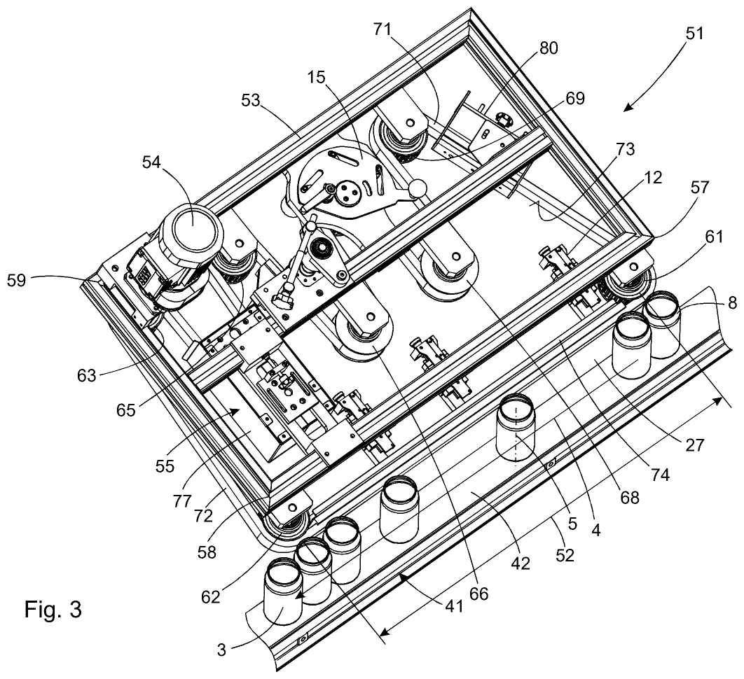

In order to enable an advantageous cleaning effect for the shoulder area 8 of the can blank 3, which is usually most heavily contaminated with lubricant, it is provided, as shown in FIGS. 2 and 3, that the front side 72 of the cleaning belt 71, which is flat in the area of the cleaning section 52, is aligned at an angle of 20 degrees (preferably adjustable by adjustment means not shown) relative to the rolling surface 27, so that as complete contact as possible between the cleaning belt 71 and the shoulder area 8 is ensured.

It is particularly preferred that the conveyor 21 and the cleaning device 51 are fixed together on a transport device 41 and thus have a defined spatial alignment with respect to each other. The transport device 41 has, by way of example, an endless conveyor belt 42, with transport rollers not shown being arranged at the end of the transport device 41 to deflect the conveyor belt 42. The conveyor belt 42 is designed to support the can blanks 3 at their bottom area. Preferably, the conveyor belt 42 is made of a material which has a low coefficient of static friction and a low coefficient of sliding friction with respect to the can blanks 3, so that the can blanks 3 rest on the conveyor belt 42 with low friction and the movement of the can blanks 3 is caused at least almost exclusively by the application of force by means of the conveyor belt 23 and the rolling surface 27.

1. A cleaning system for an external cleaning of can blanks, with a conveyor for conveying can blanks along a path of movement with a superimposed rotational movement for the can blanks about a rotational axis aligned transversely to the path of movement, and with a cleaning device which has a cleaning belt, the outer surface of which defines a cleaning section which extends at least partially along the path of movement for a contact between the cleaning belt and a surface area of the can blanks.

2. The cleaning system according to claim 1, wherein the cleaning device has a belt guide for guiding the cleaning belt, wherein the belt guide comprises a drive to provide a linear movement of the cleaning belt along the cleaning section.

3. The cleaning system according to claim 2, wherein the belt guide has a belt washing device for the cleaning belt, which belt washing device is located remotely from the cleaning section and provides a continuous washing of the cleaning belt.

4. The cleaning system according to claim 3, wherein the belt guide has a belt dryer for drying the cleaning belt, which belt dryer is located remotely from the cleaning section and provides a continuous drying of the cleaning belt.

5. The cleaning system according to claim 2, wherein a first end region of the cleaning section is defined by a first deflection roller assigned to the belt guide, which first deflection roller is at least partially surrounded by the cleaning belt, and wherein a second end region of the cleaning section is defined by a second deflection roller assigned to the belt guide, which second deflection roller is at least partially surrounded by the cleaning belt.

6. The cleaning system according to claim 1, wherein the cleaning belt is an endlessly circulating ring.

7. The cleaning system according to claim 1, wherein the conveyor has an endlessly circulating conveyor belt which partially encircles a first belt pulley, wherein the first pulley defines a start of the movement path and which partially encircles a second pulley, wherein the second pulley defines an end of the movement path.

8. The cleaning system according to claim 7, wherein the conveyor belt partially encircles a further pulley that is assigned to a drive motor.

9. The cleaning system according to claim 7, wherein a rolling surface is located opposite a conveyor belt section extending between the first pulley and the second pulley, which rolling surface is oriented parallel to the movement path and which defines a conveyor gap together with the conveyor belt section, wherein the conveyor gap is matched to an outer diameter of the can blanks.

10. The cleaning system according to claim 9, wherein the rolling surface and the conveyor belt section are aligned parallel to each other and wherein the outer surface of the cleaning belt is aligned at an angle between 0 degrees and 45 degrees relative to the rolling surface or relative to the conveyor belt section.

11. The cleaning system according to claim 9, wherein a transport device extending at least along the path of movement is arranged between a conveying plane defined by the conveyor belt section and a rolling plane defined by the rolling surface, which transport device has a circulating conveyor belt to support a bottom region of the can blanks.

12. A method for cleaning the outside of can blanks in sections, comprising the steps of: moving a conveyor belt along a path of movement, feeding a can blank into a conveyor gap which is bounded by a conveyor belt section of the conveyor belt and a rolling surface arranged opposite the conveyor belt section in order to cause the can blank to be conveyed along a path of movement with a superimposed rotational movement about a rotational axis aligned transversely to the path of movement in order to bring the can blank into contact with a cleaning belt whose outer surface defines a cleaning section which extends at least in sections along the path of movement, wherein the external cleaning of the can blank is brought about by a contact between the cleaning belt and a surface area of the can blanks.

13. A digital printing system for printing can blanks using an inkjet digital printing process, with a cleaning system, which has a conveyor for conveying can blanks along a path of movement with a superimposed rotational movement for the can blanks about a rotational axis aligned transversely to the path of movement, and which has a cleaning device with a cleaning belt, the outer surface of which defines a cleaning section which extends at least partially along the path of movement for a contact between the cleaning belt and a surface area of the can blanks, and with a digital printing machine, wherein the digital printing machine is arranged downstream of the cleaning system along a conveyor path for can blanks.

14. The digital printing system according to claim 13, wherein the digital printing machine has a machine frame with a rotatably mounted workpiece rotary table with can holders for securing individual can blanks, a drive for initiating a rotary stepping movement on the workpiece rotary table, and at least one inkjet digital print head for printing on an outer surface of a can blank held in a can holder of the workpiece rotary table.
